(19) United States
(12) Patent Application Publication
(10) Pub. No.: US 2008/0201318 A1
(43) Pub. Date: Aug. 21, 2008

(54) METHOD AND SYSTEM FOR RETRIEVING NETWORK DOCUMENTS

(75) Inventor: Steven S. McNew, Conroe, TX (US)

Correspondence Address: HAYNES AND BOONE, LLP, 901 Main Street, Suite 3100, Dallas, TX, 75202, US

(73) Assignee: LIT GROUP, INC., Houston, TX (US)

(21) Appl. No.: 11/741,356

(22) Filed: Apr. 27, 2007

Related U.S. Application Data
(60) Provisional application No. 60/796,817, filed on May 2, 2006.

(51) Int. Cl. G06F 17/30

(52) U.S. Cl. 707/5; 707/E17.014

(57) ABSTRACT

In one embodiment, a document retrieval server and method for its operation are described. The document retrieval server allows a user to search a classification index for the location of documents in an enterprise network that meet specified search criteria, and then automatically export a subset of the documents meeting the search criteria, according to one of several export methods. In one export method, a custodian relational interface is used to identify a custodian for documents meeting the search criteria, and allows the user to control export and generate reports for documents according to their custodian.

### CROSS REFERENCE TO RELATED APPLICATIONS

This application claims the benefit of the filing date of U.S. Provisional Patent Application No. 60/796,817, attorney docket no. 30712.32, filed on May 2, 2006, the disclosure of which is incorporated herein by reference.

### BACKGROUND

The present disclosure relates to electronic document handling, and more particularly, to methods and systems for locating and exporting electronic documents from a plurality of interconnected data repositories.

Organizations are frequently asked to locate documents and/or members of the organization with relevant knowledge on a particular subject. For example, an organization may be asked, as a litigant or a third party, to produce documents and/or the identification of persons with information relevant to one or more issues in a litigation matter. An organization may also desire to retrieve and review documents it possesses on a subject prior to proceeding with the litigation matter, or for other business purposes. Although these processes may be manageable for small businesses that generally have one location and one computer server/document repository, these processes can easily be daunting for a large company that may have hundreds of thousands of documents spread across several document servers in multiple locations. Thus, as the size and geographic locations of an organization and/or the volume of documents in the organization's control increases, the difficulty and expense of locating, retrieving, and analyzing documents from various document repositories generally increases as well. Therefore, there is a need in the art for an efficient document handling system that may be configured to locate and export documents form a plurality of databases that may be networked together.

### BRIEF DESCRIPTION OF THE DRAWINGS

FIG. 1 illustrates an enterprise network environment including a document retrieval server according to an embodiment;

FIG. 2 illustrates a document retrieval server according to an embodiment;

FIG. 3 contains a flowchart for a method of exporting documents and export reports according to an embodiment;

FIGS. 4 through 9 show a set of user interface screens for operating a document retrieval server according to an embodiment;

FIG. 10 shows the elements of a custodian relational interface according to an embodiment; and

FIG. 11 contains a flowchart for a method of exporting documents and generating reports by custodian, according to an embodiment.

### DETAILED DESCRIPTION

Prior to describing various embodiments of the invention, Applicant notes that the following description references exemplary embodiments of the invention. As such, the invention is not limited to any embodiment specifically described herein; rather, any combination of the following features and elements, whether related to a described embodiment or not, may be used to implement and/or practice the invention. Moreover, in various embodiments, the invention may provide advantages over the prior art; however, although embodiments of the invention may achieve advantages over other possible solutions and the prior art, whether a particular advantage is achieved by a given embodiment is not intended in any way to limit the scope of the invention. Thus, the following aspects, features, embodiments and advantages are intended to be merely illustrative of the invention and are not considered elements or limitations of the appended claims; except where explicitly recited in a claim. Similarly, references to “the invention” should neither be construed as a generalization of any inventive subject matter disclosed herein nor considered an element or limitation of the appended claims; except where explicitly recited in a claim.

Further, at least one embodiment of the invention may be implemented as a program product for use with or on a computer system. The program product may generally define functions of the exemplary embodiments (including the methods) described herein and may be contained on a variety of computer readable media. Illustrative computer readable media include, without limitation, (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, writable CD-ROM disks and DVD disks, zip disks, SDRAM and other portable memory devices, etc.); and (iii) information conveyed across communications media, (e.g., a computer bus, telephone line, network line, network switch, or any type of network configured to connect computers in either local or remote locations, such as a LAN, WAN, WAN, VPN, or SAN, and any type of wireless network). These embodiments may also include information shared over the Internet or other computer networks. Such computer readable media, when carrying computer-readable instructions that perform methods of the invention, represent exemplary embodiments of the present invention.

Further still, in general, software routines implementing embodiments of the invention may be part of an operating system or part of a specific application, component, program, module, object, engine, or sequence of instructions, such as an executable script, for example. Such software routines typically include a plurality of instructions capable of being performed using a computer system or other type or processor configured to execute instructions from a computer readable medium. Also, programs typically include or interface with variables, data structures, memory elements, etc. that reside in a memory or on storage devices as part of their operation. Additionally, various programs described herein may be identified based upon the application for which they are implemented. Those skilled in the art will readily recognize, however, that any particular nomenclature or specific application that follows facilitates a description of the invention and does not limit the invention for use solely with a specific application or nomenclature. Furthermore, the functionality of programs described herein may use a combination of discrete modules or components interacting with one another. Those skilled in the art will recognize, however, that different embodiments may combine or merge such components and modules in a variety of ways.

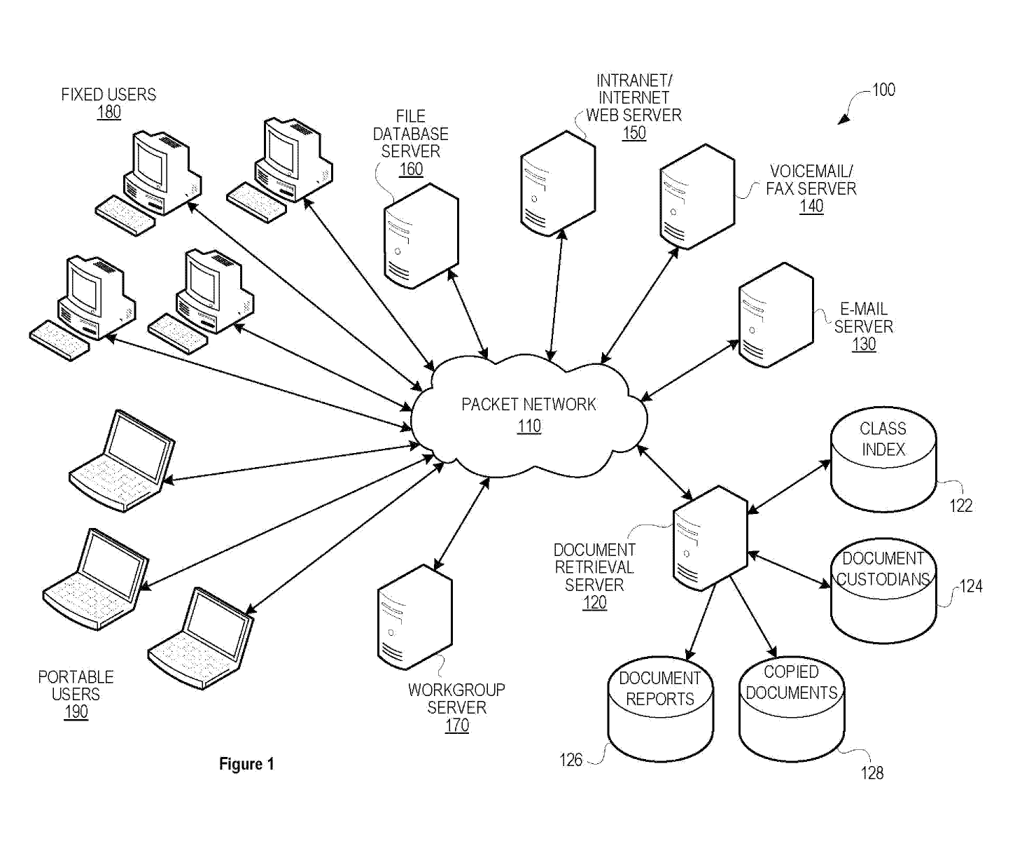

Returning to the exemplary embodiments of the invention, within the general field of document identification and retrieval, specific challenges exist with regard to identification and retrieval of documents based on Electronically Stored Information (ESI). The general trend, as electronic data storage costs/Gigabyte continue to decrease and as more document types are originally created electronically, is for organizations to collect ever greater amounts of ESI, in an increasing number of formats and on a large number of separate systems. For instance, FIG. 1 shows exemplary elements of an Enterprise Network 100. The backbone of the Enterprise Network is a packet network 110, generally comprising packet routers, switches, bridges, hubs, Local Area Networks (LANs), wireless LANs, firewalls, Wide Area Network (WVAN) connections providing dedicated and/or virtual connectivity between campuses, etc.

The computer systems necessary for the operation of the enterprise generally connect to the packet network 110. For instance, an e-mail server 130 receives and sends electronic mail for enterprise e-mail accounts, and archives/serves the electronic mail to the e-mail account owners. A voicemail/fax server 140 connects to an enterprise PBX (Private Branch Exchange), allowing voice mailbox owners to receive and review voicemail and receive and send facsimiles from the various workstations 180, 190. An Intranet/Internet Web Server 150 serves internal web pages to enterprise members and public web pages to external customers, and may interface with the other servers to create, retrieve, and/or store web content. A file database server 160 allows enterprise users to save, backup, share, and exercise version control over documents that they create. A workgroup server 170 may maintain file repositories, programs, and other data needed by an enterprise workgroup, generally in a network location convenient to the users of that server. Fixed user workstations 180 include personal computers and other workstations containing local data storage, primarily for the local files and programs used by one or more persons that operate the computer from a fixed location. Portable user workstations 190 operate similarly to the fixed user workstations 180, but often have the flexibility to connect to the network from a variety of wired connection points, wireless LANs, and or Virtual Private Networks (VPNs) operated through the Enterprise Network firewall. Some additional fixed user workstations (not shown) could also be physically located outside the Enterprise Network and connect by VPN through the firewall, for example.

The Enterprise Network 100 may be simpler than shown, or much more complex, depending on the needs of the organization. Some organizations may not use all of the services shown, some organizations may combine services on fewer servers, and some organizations may contain sophisticated server farms and/or distributed servers to provide these services. Many organizations may be spread across multiple campuses, often in different cities or even countries, and may duplicate some functionality at each location. What is generally common in all such networks, however, is that a substantial number of users are creating and consuming data in a variety of application formats and on a substantial number of networked data repositories, on a daily basis.

A substantial challenge is presented when an organization needs to determine what, if any, Electronically Stored Information specific to a given subject exists on mass storage media connected to its networked computers. Not only is the volume of data contained in the enterprise's documents often too great to store in one location (a design that is also undesirable for a number of reasons), but the volume of data extant on the network is so great that attempting to search all data across the enterprise's computers for ESI related to a subject could slow the network and critical computers sufficiently to impair the enterprise's normal operations—and would not in any event provide a timely response to a query. As a further complication, ESI is stored in many different formats, such as electronic mail archives, digitized voice files, word processor-readable files, spreadsheets, presentations, drawing application files, databases, Extensible Markup Language (XML) files, Hypertext Markup Language (HTML) files, Portable Document Format (PDF) files, etc., and may be stored in multiple languages.

To tackle problems such as web searching, several vendors have created knowledge management tools that allow an automated server to efficiently characterize the documents residing on one or more networked data repositories. These knowledge management tools can be configured to “crawl” the Internet, or a local Intranet or a specified portion thereof, e.g., during off-hours, to locate documents that have been added or changed since the last update. The new documents are analyzed, e.g., using advanced pattern-matching techniques, to classify each document according to its likely subject (classification can also be augmented by any Metadata stored within the documents themselves). This classification is added to a local classification index for the documents in the search domain. The local classification index can then be searched, quickly and independent of the networked documents themselves, for documents with a particular classification. Thus a user looking for a specific document, e.g., a specific article at a news service, can be provided with a list of one or more possible “hits” for a search term related to the specific article.

One such knowledge management tool is the Intelligent Data Operating Layer (IDOL) Server, offered by Autonomy Corporation Ltd., Cambridge, UK. Operation of the classification engine components of the Autonomy IDOL server is described in U.S. Pat. No. 6,668,256, “Algorithm For Automatic Selection Of Discriminant Term Combinations For Document Categorization,” incorporated herein by reference.

It has now been discovered that a knowledge management tool can be incorporated into a sophisticated document retrieval system for an organization possessing distributed ESI. This document retrieval system is useful for litigation (pre-filing analysis, report generation, response to discovery requests) and other document gathering tasks. The document retrieval system allows users to automatically export copies of groups of documents (from a variety of computers and a variety of document formats) relevant to a specific issue according to an export method, while also preparing valuable reports and performing other export-related analysis, with minimal user effort.

In FIG. 1, the exemplary document retrieval server 120 is illustrated connected to packet network 110. Document retrieval server 120 can therefore potentially inspect and retrieve documents residing on servers 130, 140, 150, 160, and 170, as well as documents residing on user computers 180 and 190. A document classification engine, e.g., running within a knowledge management tool, creates a classification index 122 that is accessible to the document retrieval server 120. Server 120 also maintains a document custodian relational interface, part of which is a document custodian index 124. The document custodian index 124 maintains relationships between identification features that can be gleaned from the classification index 122 and the actual person or persons that are the likely “custodians,” e.g., those with knowledge of, the documents. For instance, e-mail addresses, voice mailbox numbers, domain usernames, computer MAC addresses, etc., may all provide clues for certain documents in certain circumstances as to the identity of a document custodian.

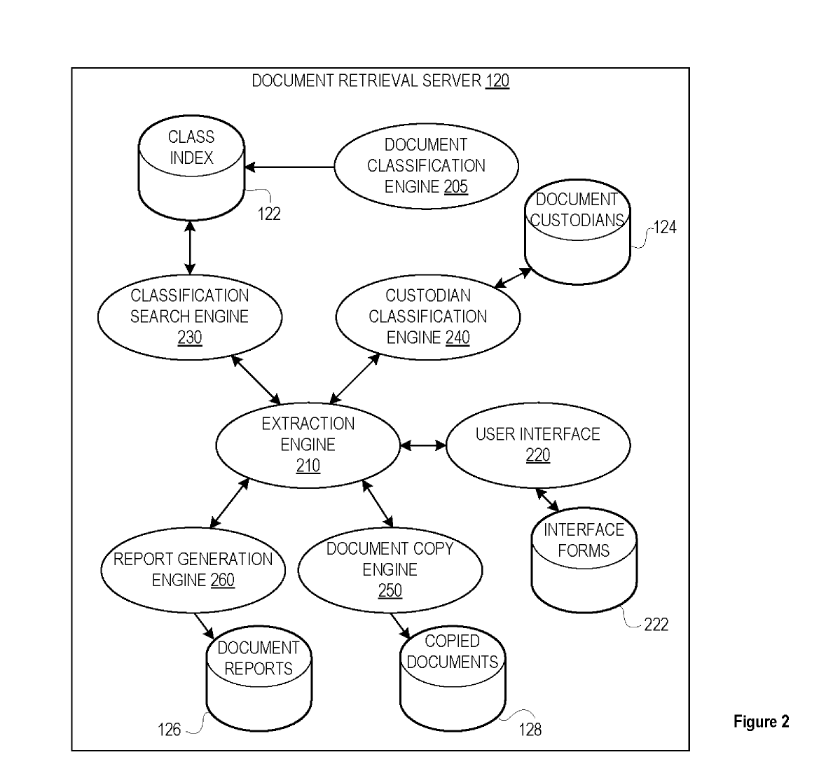

Given the classification index 122 and the document custodian index 124, the document retrieval server 120 can produce export copies of documents 128 responsive to a search according to one of several export methods, and/or generate export-related reports and analysis 126. FIG. 2 illustrates the major functional blocks through which document retrieval server 120 accomplishes these tasks.

In FIG. 2, a collection of “engines” are used to process the classification index and document custodian index, according to search and export instructions provided through a user interface. Each engine is generally a process or portion of a software process, running on one or more processors with document retrieval server 120 (although in principle, the “server” could comprise multiple cooperating computers). Each engine will now be addressed in turn.

A document classification engine 205 is responsible for locating documents in the network, classifying those documents, and creating and updating classification index 122. This engine can be, e.g., a component of a knowledge management tool such as those described above. The engine is provided with analysis capabilities for a given set of document types, and may also be provided with direction as to which network computers are to be searched. It is noted that the engine itself may be partitioned to various of the data servers in a network, which each classify documents residing on that server and report classification information to document classification engine 205 on document retrieval server 120.

An extraction engine 210 coordinates the various tasks necessary to provide document export and report generation. Extraction engine 210 receives user input from and provides user output to a user interface 220. Based on user input, extraction engine 210 provides queries to a classification search engine 230 and receives document identification information in response. Extraction engine 210 can provide document identification information from the classification index to a custodian classification engine 240 to receive custodian identification for identified documents. The extraction engine also provides instructions to a document copy engine 250 as to what documents are to be extracted, from where, and in what arrangement. Finally, extraction engine 210 provides data and instructions to a report generation engine 260 for any reports that are to be generated.

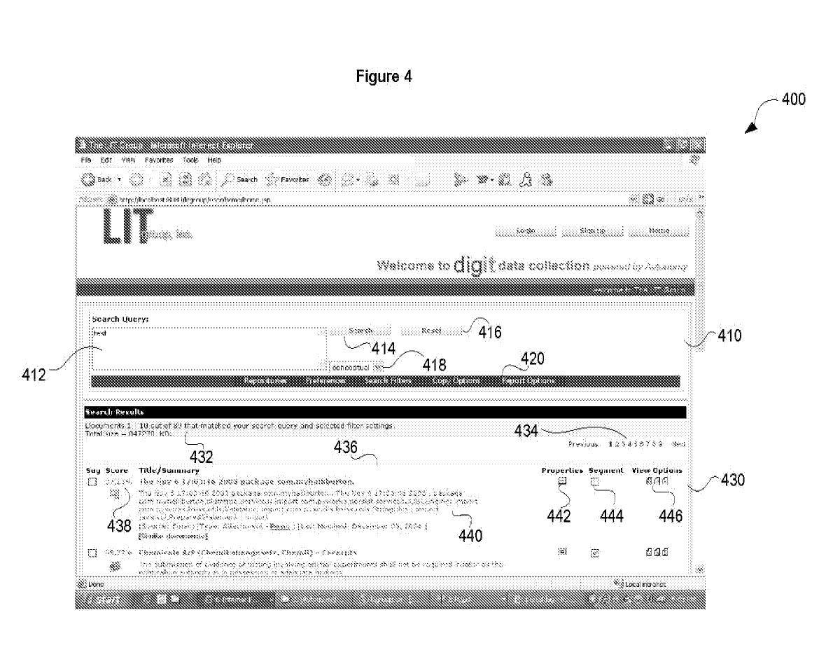

User interface 220 presents interface forms 222 to a user, customized for each task. For instance, user interface 220 in one embodiment uses script language forms to generate HTML pages to a user, which the user can then manipulate to respond with instructions to the document retrieval server. Exemplary HTML display pages for a query and response are shown in FIGS. 4-8, which will be described in turn.

FIG. 4 shows a first user interface view 400, including a search pane 410 and a search results pane 430. Search pane 410 includes a query text entry box 412, a search button 414, a reset button 416, a search method selection box 418, and a preference selection block 420. Query text entry box 412 allows a user to type a search query, using natural language and/or keywords joined with Boolean operators. Search button 414 sends the search query from query text entry box 412 to extraction engine 210, which then processes the search query according to the other settings that will be explained below. Reset button 416 clears the query text entry box and resets all processing options to their default values. Search method selection block 418 allows the user to select either keyword searching or conceptual searching, with conceptual searching providing a broader-based search for documents containing similar concepts as those expressed in the query text entry box. Preference selection block 420 contains hypertext links that activate additional panes for controlling other features of document retrieval server 120, as will be explained below.

Search results pane 430 displays information for documents identified by a search entered in search pane 410. General information as to how many documents matched the search query and the total size of the documents in Kilobytes, and which portion of those match documents are represented on this page, are shown in a general information field 432. When the number of documents returned exceeds the settings for number of documents/page, multiple search results panes 430 can be navigated using pane navigation hypertext links 434. Each hypertext link 434 instructs user interface 220 to generate a new HTML page with a search results pane 430 for a corresponding subset of the search results.

The remainder of search results pane 430 comprises a list of document information/controls for search query results. For each document, a score field 438 represents a relevance score based on an assessment performed by classification search engine 230 (FIG. 2). A title/summary field 440 presents descriptive information from the document, its pertinent dates, document type, links to other related documents, etc. A properties button 442 allows the user to see additional information on the document. A segment checkbox 444 identifies whether the document should be exported with the export documents, should the export method be based on manual selections. View options 446 allow the user to fetch the document and display it to the user in one of several view formats, if multiple formats are available.

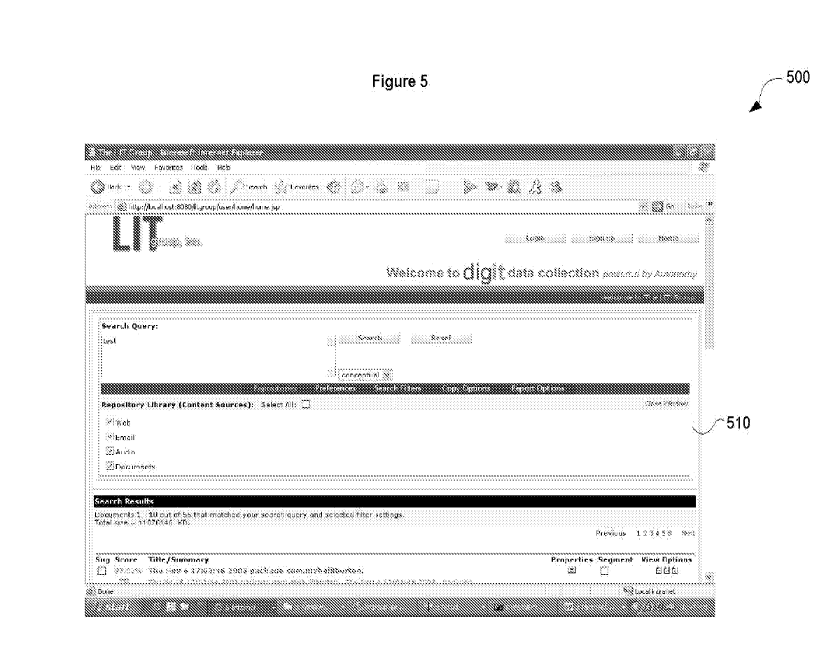

Preference selection block 420 allows the user to open up additional panes to control the search and export functions. When a user selects the hypertext link “Repositories” in preference selection block 420, a new HTML page 500 is displayed, as shown in FIG. 5. On HTML page 500, a repository selection pane 510 is now visible, showing all content sources available for searching. In exemplary repository selection pane 510, four content sources are available: “Web,” representing HTML documents, etc.; “Email,” for searching e-mail archives; “Audio,” representing voice messaging and other audio files; and “Documents,” which represent one or more standard document formats (word processing, spreadsheet, presentation, PDF, etc.) that were classified by document classification engine 205 (FIG. 2). Each content source is accompanied by a check box, allowing the user to limit a search to specified repositories. When submitted, the content source selections are conveyed to classification search engine 230 (FIG. 2) to limit the scope of the current search query.

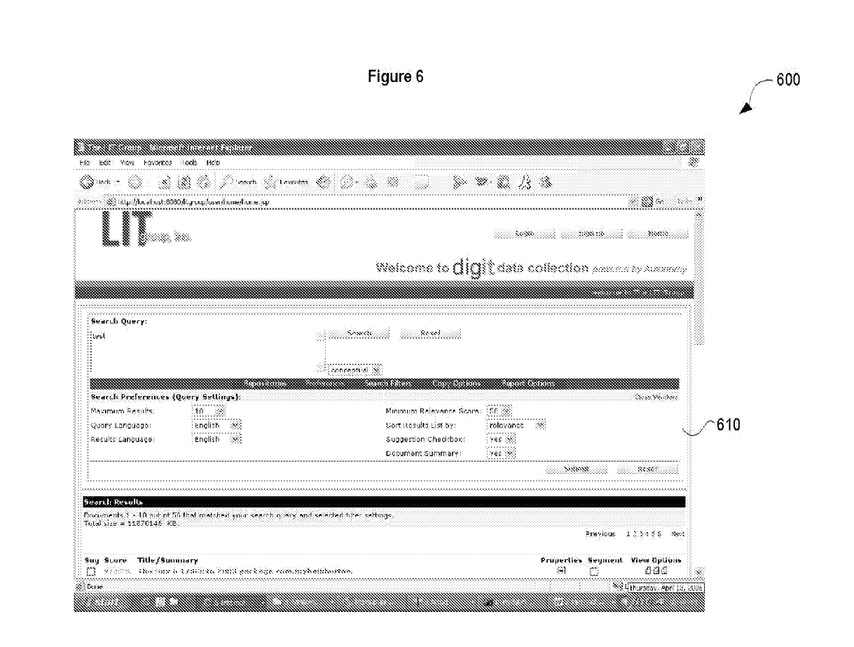

A user can also select the hypertext link “Preferences” in preference selection block 420 of FIG. 4. This causes a new HTML page 600 to be displayed, as shown in FIG. 6. On HTML page 600, a search preferences pane 610 is now visible, showing various additional controls for tailoring the search and the display of search results. When submitted, these preferences are conveyed to classification search engine 230 (FIG. 2) to further define the current search query.

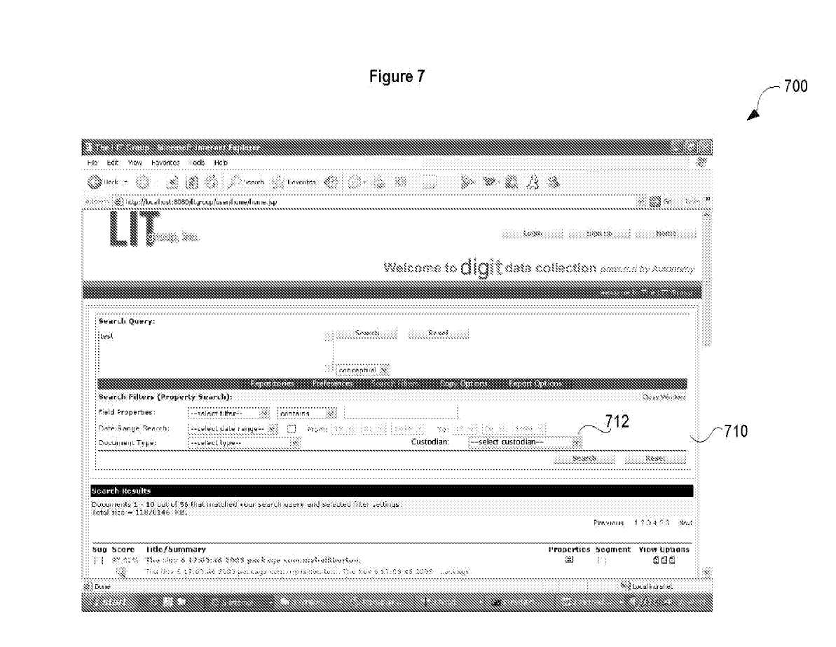

When a user selects the hypertext link “Search Filters” in preference selection block 420 (FIG. 4), a new HTML page 700 is displayed, as shown in FIG. 7. On HTML page 700, a search filters pane 710 is now visible. Using search filters pane 710, the user can select additional filters based on specific field properties, data ranges, and document types to further tailor the search. An additional filter is provided for custodian, via a dropdown menu 712, using custodians available from custodian classification engine 240. When submitted, these preferences are conveyed to classification search engine 230 (FIG. 2) to further define the current search query. In the FIG. 2 architecture, custodian is not a field or property directly available from classification index, but is a property derived from other information. Accordingly, server 120 can either a) retrieve applicable alias information for the selected custodian(s) from document custodian relational index 124, and use this information to augment the search submitted to classification search engine 230, or post-filter the results returned by classification search engine by submitting search result document information to custodian classification engine 240, and filtering documents that do not have the requested custodian(s) before returning results to the user.

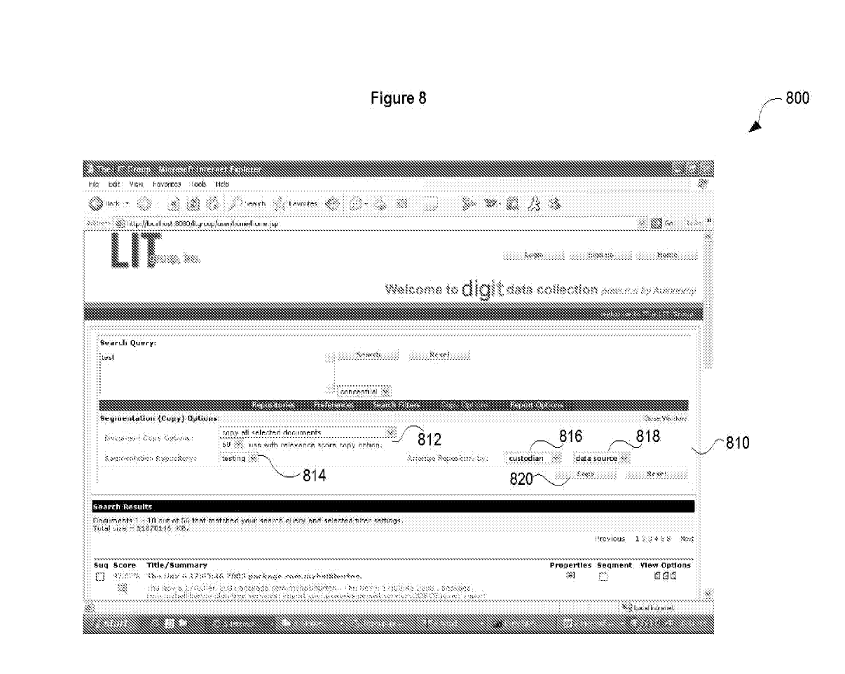

When a user selects the hypertext link “Copy Options” in preference selection block 420 (FIG. 4), a new HTML page 800 is displayed, as shown in FIG. 8. On HTML page 800, a segmentation options pane 810 is displayed, containing document copy options controls 812, segmentation repository control 814, segmentation arrangement controls 816 and 818, and a copy button 820. The user selects an export method from a pull down menu in document copy options controls 812. The export tree directory tree will be created in the repository indicated in segmentation repository control 814, with a tree structure specified by segmentation arrangement controls 816 and 818. Copy button 820 actually begins the export according to the selected method.

Possible export methods include “copy all documents,” “copy all selected documents,” “copy all documents with a relevance score above,” “copy all documents from custodian,” and “copy all documents from data source.” The “copy all documents” method exports all documents responsive to the current search query (which is further limited by the Repositories, Preferences, and Search Filters controls). The “copy all selected documents” method exports all documents responsive to the current search query with the “Segment” checkbox selected in search results pane 430 (FIG. 4). The “copy all documents with a relevance score above” method exports all documents responsive to the current search query with a relevance score higher than a specified value (specified by a dropdown menu in document copy options 812). The “copy all documents from custodian” method exports all document responsive to the current search query that have been matched to a designated custodian (specified by a dropdown menu, not shown in FIG. 8, for available custodians). The “copy all documents from data source” method exports all documents responsive to the current search query from a designated data source (specified by a dropdown menu, not shown in FIG. 8).

The user also specifies a segmentation repository tree structure using dropdown lists 816 and 818 to specify a directory structure for arranging the exported documents. Dropdown list 816 specifies a first-level tree structure, and dropdown list 818 specifies an optional second-level tree structure. Possible tree structure selections include arrangements by custodian, data source, document type, department, campus, and flat (single directory). When two tree structure types are selected, for instance by custodian by data source as illustrated, the exported documents will be divided in the segmentation repository into multiple subdirectories, one named for each custodian in the export list. Each custodian subdirectory will contain a further subdirectory for each data source containing an export document associated with that custodian.

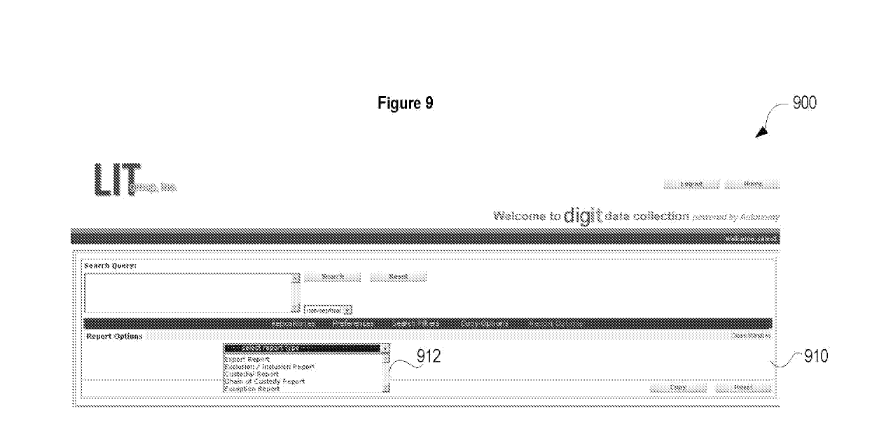

When a user selects the hypertext link “Report Options” in preference selection block 420 (FIG. 4), a new HTML page 900 is displayed, as shown in FIG. 9. On HTML page 900, a report options pane 910 is displayed, containing a dropdown menu 912. Dropdown menu 912 contains selections for various reports that can be generated, as will be explained in more detail below in conjunction with the explanation of report generation engine 260.

Referring again to FIG. 2, classification search engine 230 provides the search capability for document classification index 122. In one embodiment, classification search engine 230 is provided as part of a knowledge management tool that also includes the document classification engine 205. Classification search engine 230 receives structured search parameters from extraction engine 210, as distilled from the search query input provided on HTML pages 500, and performs a search. The results of the search, e.g., records identifying each matching document and at least some of that document's properties, are returned to extraction engine 210 in a structured format. Extraction engine 210 can then use these results to query custodian classification engine 240, pass data to user interface 220 for building search results pane 430 (FIG. 4), and pass data to document copy engine 250 and report generation engine 260 as needed.

The custodian classification engine 240 identifies custodians based on document information supplied by extraction engine 210 and document custodian relational index 124, as will be further explained after the general explanation of server 120 and its operation is completed. Custodian identification is used, e.g., in implementing some export methods and in generating some reports.

Document copy engine 250 performs the export of documents according to the user's export method. For example, engine 250 accepts a list of documents with their original data sources and pathnames, a custodian associated with each document, and user selections for a segmentation path and an arrangement of the documents by custodian by data source. Engine 250 examines the custodian and data source of the first document in the list, and creates a directory <segmentation path>/<custodian>/<data source>. Engine 250 then attempts to access and copy the first document to this new directory, preserving all attributes and timestamps, using a utility such as the Microsoft utility ROBOCOPY.exe. Engine 250 logs the result of this operation in a log file, and indicates in the log file whether the copy operation was successful. These steps are repeated for the second and each successive document in the list, creating directories as necessary to store the documents in the requested export file structure.

Report generation engine 260 creates reports based on report requests from user interface 220 and results obtained from one or more of classification search engine 230, custodian classification engine 240, and document copy engine 250. The following are some examples of reports that can be generated by engine 260.

When the user selects an “export report”, report generation engine 260 accesses the log file for export copies completed during this session. The log file is formatted to report what actions were attempted, in what order, and indicate their success.

When the user selects an “exclusion/inclusion report”, report generation engine 260 generates a report indicating what documents were returned by the search, and indicate which were excluded and which were included in the export segmentation path. For the excluded documents, a reason for the exclusion-for instance, copy failure, manual de-selection, failure to meet relevance criteria for export, duplicate of another document, etc.

When the user selects a “custodian report”, report generation engine 260 generates a report indicating the search result documents in the possession of each custodian, e.g., arranged by custodian with an indication of the custodian's name, title, and department. The custodian report can be run after an export operation, in which case it provides a method for matching the exported documents with their custodians. The custodian report can also be run without a corresponding export operation, in which case it provides a method for matching potentially exportable documents with custodians, for the current search query. The report can optionally list custodians in descending order, from the custodian with the largest amount of data or largest number of responsive documents first, and can optionally provide a summary of the aggregate amount of data (e.g., kilobytes or pages) located for each custodian. The report can estimate costs to copy, analyze, and review responsive documents, based on formulas relating cost to data amount. Finally, the report can also summarize the accessible repositories and accessible system names. These features make the report attractive for automatically summarizing the types of information that may be required or desirable in conferring with opposing counsel in a lawsuit regarding the scope of discovery, its costs, and the identification of persons having discoverable information on subjects at issue in the lawsuit.

When the user selects a “chain of custody report”, report generation engine 260 generates a report indicating when the export was attempted and by who, all settings used for search and export, a list of the data sources that were visited to obtain the export copies and when they were visited, and a list of the exported files. Such a report can be supplied along with the export copies, e.g., in response to a discovery request, to show the level of care taken in compiling export documents that are exact copies of the originals. The report can also note files that were unsuccessfully copied, e.g., because a data source was offline at the time of export.

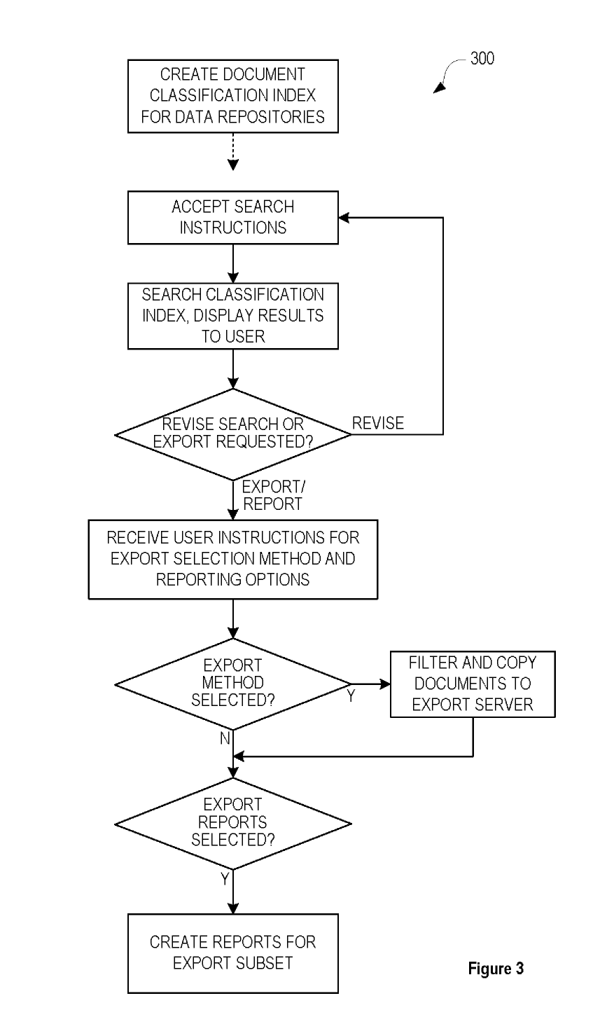

The ability to automatically export documents and generate reports on the export, and/or generate “what, where, who, and how much” information for possible search scenarios prior to export, provide great benefits in the collection of ESI for litigation, project archival, etc. For instance, FIG. 3 contains a flowchart 300 showing the steps necessary in executing an export operation and/or report operation. First, a document classification index is created for one or more data repositories, for one of more data sources. The document classification index is generally “precompiled” prior to a search, e.g., by running a single exhaustive fetch-and-classify operation for an entire network, followed by incremental fetch-and-classify operations, e.g., run once a day, to update the document classification index for new and updated documents. The index can be created solely for use by the document retrieval server, or it can be shared with other knowledge management tools.

Once the document classification index is ready, a user with appropriate permission accesses the system to create search instructions. The server accepts the users search instructions, e.g., entered on one or more of the HTML pages shown in FIGS. 4-7, searches the classification index, and displays results to the user as explained above. The user can then choose to modify the search and repeat these steps, or to move forward and export documents and/or generate reports. When the user chooses to move forward, the server receives the user instructions, entered for instance on one or both of the HTML pages shown in FIGS. 8 and 9, for the report and export operations. When an export method is selected, export filters are applied and documents are copied from their original data sources and repositories to the designated segmentation repository, in the designated segmentation arrangement. Whether an export method is selected or not, if export reports are selected the reports are created for the actual (or potential) export subset.

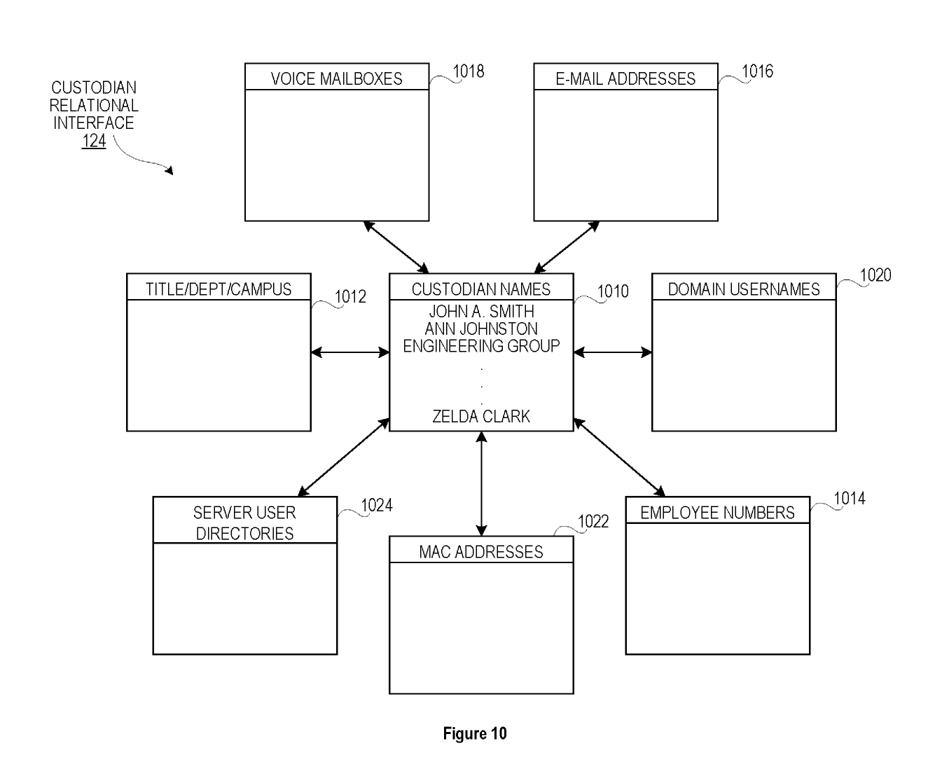

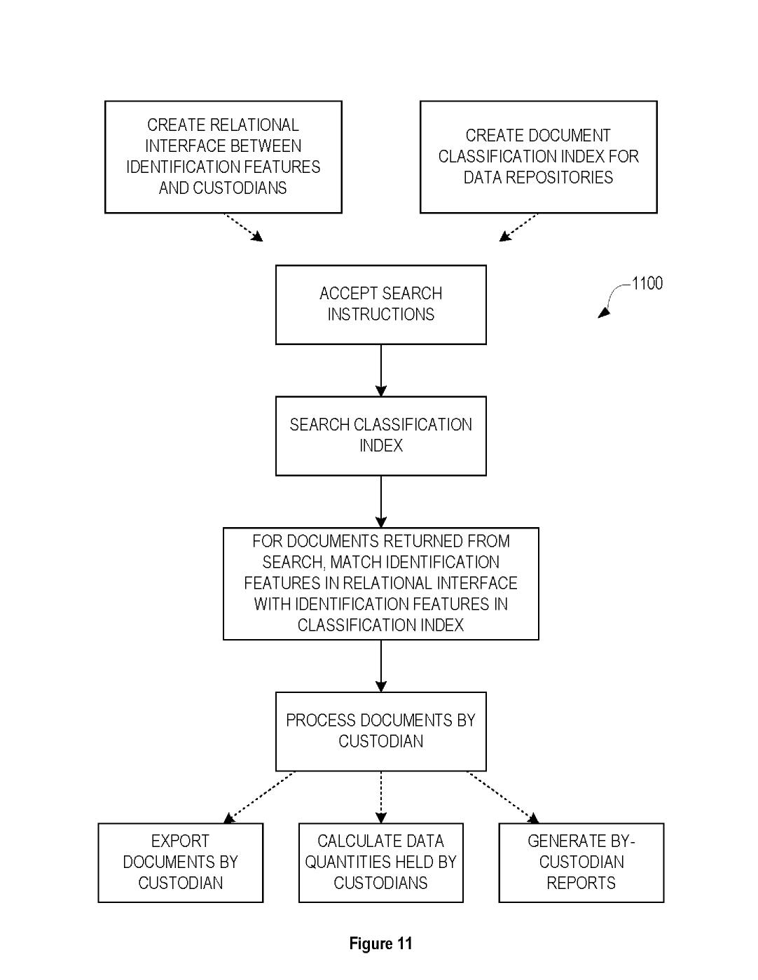

In many organizations, individual custodians create electronic documents (knowingly and unknowingly) in many different repositories and on many different computers. Many of these documents contain no explicit identification of the custodian by legal name, and/or use inconsistent versions of the custodian's name or nicknames. In many organizations, custodians can also share the same or very similar legal names. In most circumstances, however, some document identification information can tie the document back to one legal name. FIGS. 10 and 11 explain the arrangement and operation of a custodian relational interface and custodian classification engine that can attempt a reliable match between document and custodian for a variety of document types and document locations.

FIG. 10 shows elements of a custodian relational interface 124. One database 1010 contains a list of custodian names, e.g., legal names obtained from a human resources database, and/or group custodians, such as “engineering group.” A field in database 1010 can indicate whether the custodian is an individual or a group custodian. A related database 1012 indicates a title, department, and/or campus for at least some of the custodians. For individual custodians, an employee number database 1014 can also identify the custodians by employee number.

A database 1016 contains a list of e-mail addresses recognized by the organization's e-mail servers. Each is linked to a custodian in database 1010 (some custodians may have more than one valid e-mail address). A database 1018 contains a list of voice mailbox numbers, each linked to one of the custodians in database 1010. A domain username database 1020 lists login names to organizational computers, as are often used to administer documents stored in a server-based document management system.

Other databases can contain identification information that is based on where a document is stored. For instance, when personal and laptop computers are assigned to individuals, the custodian classification engine may be able to classify documents on such a computer when those documents contain none of the other information identified above. Such computers have one or more network interfaces, each of which is assigned a MAC address that is unique. Thus a MAC address database 1022 can link, for many computers, an identification of a MAC address to a custodian. Similarly, users who share file space on a file server are generally given a root subdirectory under which they may store files. A server user directories database 1024 can list such root subdirectories and link them to their custodians.

The elements of custodian relational interface 124 allow a variety of document types and sources to be identified by custodian, with a consistent relationship to one custodian name. Flowchart 1100 of FIG. 11 illustrates one way of processing documents by custodian given the custodian relational interface of FIG. 10.

In similar fashion to FIG. 3, in FIG. 11, a document classification index for one or more data repositories is assumed to have been precompiled. A relational interface PATENT between identification features and custodians, e.g., representing one or more of the relationships shown in FIG. 10, is also precompiled. The system accepts search instructions, e.g., from one or more of the HTML pages illustrated in FIG. 4-7, and searches the classification index for matching document results.

For each document result returned, an extraction engine requests that a custodian match be made by a custodian classification engine using the custodian relational interface. Depending on document type, the custodian classification engine may employ different strategies to determine a custodian. These strategies will glean identification information from the document result, and attempt a match to one or more of databases 1016, 1018, 1020, 1022, and 1024. When a match is made, the custodian classification engine returns linked information, e.g., from databases 1010, 1012, and/or 1014.

Once the extraction engine has obtained the custodian information for one or more documents, it may then proceed to direct the processing of documents by custodian. For instance, with a consistent custodian indication for a variety of repositories, documents of different types can be reliably exported by custodian, or grouped in order to calculate data quantities held by various custodians, or to generate by-custodian reports.

The actual organization of the custodian relational interface can take many different structures, and may contain more or less custodian identification information than what is shown. Not all custodians need to be represented in each linked database. It is also possible that the relational interface can be used to identify custodians for one or more documents prior to a search, with the custodian identification stored in the document classification index.

Although illustrative embodiments have been shown and described the elements and their operation can be arranged and partitioned in other ways. A wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A computer program embodied on a computer readable medium, that when run by the computer, is configured to retrieve documents stored in a group of networked computers with a classification index available for a plurality of documents stored on the group of networked computers, the document retrieval process comprising:
performing a search of the classification index to identify a subset of the plurality of documents;
receiving user instructions for an export selection method that determines documents from the subset for export and an arrangement for the exported documents; and
automatically exporting the subset of the plurality of documents from the group of networked computers to an export location, according to the export selection method.

2. The computer program of claim 1, comprising providing a user with a graphical interface allowing the user to specify search parameters and enter instructions for the export selection method.

3. The computer program of claim 1, wherein the export method further comprises selecting documents from the subset based on a data source hosting the documents.

4. The computer program of claim 1, wherein the export method further comprises identifying a custodian for documents in the subset, and selecting documents from the subset based on the custodian.

5. The computer program of claim 1, wherein the export method further comprises selecting documents from the subset for export based on a relevancy ranking calculated for documents in the subset.

6. The computer program of claim 1, further comprising generating a chain of custody list for the documents exported to the export location.

7. The computer program of claim 6, wherein the chain of custody list further indicates documents in the subset that were not exported to the export location.

8. The computer program of claim 7, wherein the chain of custody list indicates whether a document in the subset was not exported to the export location due to copy failure.

9. The computer program of claim 6, wherein the chain of custody list indicates the original location of each exported document in the group of networked computers.

10. The computer program of claim 6, wherein the chain of custody list identifies the original custodian of each exported document.

11. The computer program of claim 6, wherein the chain of custody list identifies the date each exported document was exported and original date information for each exported document.

12. The computer program of claim 6, wherein the chain of custody list identifies the search that resulted in identification of the exported documents for export.

13. The computer program of claim 6, further comprising identifying duplicate documents in the subset of the plurality of documents, and indicating in the chain of custody list whether a document in the chain of custody list is a duplicate of another document in the chain of custody list.

14. The computer program of claim 13, wherein identifying duplicate documents in the subset comprises identifying duplicate documents with a common custodian.

15. The computer program of claim 13, wherein identifying duplicate documents in the subset comprises identifying duplicate documents regardless of custodian.

16. The computer program of claim 1, further comprising identifying duplicate documents in the subset of the plurality of documents, and selecting one copy of the duplicate documents in the subset for export.

17. The computer program of claim 16, wherein identifying duplicate documents in the subset comprises identifying duplicate documents with a common custodian.

18. The computer program of claim 16, wherein identifying duplicate documents in the subset comprises identifying duplicate documents regardless of custodian.

19. The computer program of claim 16, further comprising generating a list of duplicated documents.

20. The computer program of claim 1, further comprising generating an exclusion/inclusion report for the subset of the plurality of documents, identifying documents in the subset that were not exported according to the export selection method.

21. The computer program of claim 20, further comprising indicating on the exclusion/inclusion report a reason for the non-selection for export of a document in the subset.

22. A method for processing documents stored in a group of networked computers, where the documents have a classification index available for a plurality of documents stored on the group of networked computers, the plurality of documents stored in at least one format, the method comprising:
selecting at least one identification feature available in the classification index for documents stored in the at least one format;
creating a relational interface that links the identification features to custodians;
for at least a subset of the plurality of documents, matching the at least one identification feature available in the classification index to an identification feature in the relational interface to identify the custodian of that document; and
processing the at least a subset of the plurality of documents by custodian.

23. The method of claim 22, further comprising performing a search of the classification index to identify the at least a subset of the plurality of documents.

24. The method of claim 23, wherein processing the at least a subset of the plurality of documents by custodian comprises generating a report identifying custodians in possession of documents responsive to the search.

25. The method of claim 24, wherein the link mapping table further comprises information identifying the title and/or department of each custodian, and wherein generating the report further comprises identifying the title and/or department of the custodians in possession of documents responsive to the search.

26. The method of claim 24, wherein processing the at least a subset of the plurality of documents by custodian comprises calculating an amount of data held by each custodian in possession of documents responsive to the search, and including the amount of data in the report for each custodian in possession of documents responsive to the search.

27. The method of claim 26, wherein the amount of data is specified at least as a number of documents.

28. The method of claim 26, wherein the amount of data is specified at least as an aggregate size of the documents held by each custodian.

29. The method of claim 26, further comprising estimating, from the amount of data held by each custodian, a cost for extracting the documents from the group of networked computers and supplying the extracted documents to a user.

30. The method of claim 23, wherein processing the at least a subset of the plurality of documents by custodian comprises extracting the at least a subset of the plurality of documents from the group of networked computers, and arranging the extracted documents in an order determined by custodian.

31. The method of claim 23, wherein processing the at least a subset of the plurality of documents by custodian comprises generating an export tree for the at least a subset of the plurality of documents, the export tree arranged by custodian.

32. The method of claim 22, wherein the at least one format comprises a database format having database records, and wherein the at least one identification feature comprises a user name linked to each database record, and wherein the relational interface links the user name to a custodian name.

33. The method of claim 32, wherein the database records comprises electronic mail records.

34. The method of claim 22, wherein the identification feature comprises a location identifier for a document, and wherein the relational interface links location identifiers with custodian names.

35. The method of claim 34, wherein the location identifier comprises a network address.

36. The method of claim 34, wherein the location identifier comprises at least a portion of a file pathname.

37. The method of claim 22, wherein the identification feature comprises a voice mailbox number, and wherein the relational interface links voice mailbox numbers with custodian names.

38. The method of claim 22, wherein the identification feature comprises a domain username.

39. The method of claim 22, wherein the identification feature comprises an employee number.
